(19) United States
(12) Patent Application Publication
(10) Pub. No.: US 2009/0010617 A1
(43) Pub. Date: Jan. 8, 2009

(54) Method and Apparatus for Optimizing Space Allocations for Digital Video Recordings

(75) Inventors: Angela Richards JONES, Durham, NC (US); Lisa Anne SEACAT, San Francisco, CA (US)

Correspondence Address: MOLLBORN PATENTS, INC.;ATTN: IBM, 2840 COLBY DRIVE, BOULDER, CO, 80305, US

(73) Assignee: International Business Machines Corporation, Armonk, NY (US)

(21) Appl. No.: 11/773,546

(22) Filed: Jul. 5, 2007

(51) Int. Cl. H04N 7/26

(52) U.S. Cl. 386/124; 386/E05.003

(57) ABSTRACT

A method for processing a digital video recording that includes storing the digital video recording onto a storage, in which the digital video recording is to be subsequently viewed by a user. The method further includes receiving user input selecting the digital video recording for viewing, and responsive to the user input, playing back the digital video recording to the user. The method further includes simultaneously deleting a viewed portion of the digital video recording from the storage as the user views the digital video recording during playback of the digital video recording.

### FIELD OF THE INVENTION

The present invention relates generally to data processing, and more particularly to processing digital video recordings.

### BACKGROUND OF THE INVENTION

A digital video recorder (DVR) or personal video recorder (PVR) is a device that records video in a digital format, e.g., to a disk drive or other medium or storage. The term includes stand-alone set-top boxes and software for personal computers which enables video capture and playback to and from disk. Some consumer electronic manufacturers have started to offer televisions with DVR hardware and software built in to the television itself. While a digital video recorder (DVR) permits people to record television programs for later viewing, one issue that can quickly turn into an annoying problem is limited storage (or memory space) on the DVR device. For example, when all of the memory space is utilized, new television shows may not be recorded or previously recorded television programs may be automatically deleted in order to ensure that there is enough memory space to record future scheduled programs. The automatic deletion of television programs from storage, however, poses a problem for users, as users may feel that there is a race against a clock to watch an entire television program prior to the television program being deleted.

### BRIEF SUMMARY OF THE INVENTION

In general, this specification describes a method and a computer readable medium encoded with a computer program for processing a digital video recording. The method includes storing the digital video recording onto a storage, in which the digital video is a recording to be subsequently viewed by a user. The method further includes receiving user input selecting the digital video recording for viewing, and responsive to the user input, playing back the digital video recording to the user. The method further includes simultaneously deleting a viewed portion of the digital video recording from the storage as the user views the digital video recording during playback of the digital video recording.

Implementations can include one or more of the following features. Storing the digital video recording onto a storage can include storing the digital video recording onto a disk drive. The method can further include receiving user input marking one or more sections of the digital video recording with markers during play back of the digital video recording. Simultaneously deleting a viewed portion of the digital video recording from the storage as the user views the digital video recording can include deleting the one or more marked sections or deleting one or more unmarked sections of the digital video recording from the storage. The method can further include (prior to play back of the digital video recording) receiving user input specifying predefined intervals at which the user is to be prompted to determine if a portion of the digital video recording should be deleted, in which simultaneously deleting a viewed portion of the digital video recording from the storage as the user views the digital video recording during playback of the digital video recording includes only deleting a viewed portion of the digital video recording responsive to user input affirmatively indicating at a given prompt that the viewed portion of the digital video recording should be deleted.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of a data processing system in accordance with one implementation.

FIG. 2 illustrates a method for deleting a digital video recording from storage in accordance with one implementation.

FIG. 3 is a graph illustrating deletion of a portion of a digital video recording in accordance with one implementation.

FIG. 4 is a graph illustrating deletion of a portion of a digital video recording in accordance with one implementation.

FIG. 5 is a block diagram of a data processing system suitable for deleting a television program from storage in accordance with one implementation of the invention.

Like reference symbols in the various drawings indicate like elements.

### DETAILED DESCRIPTION OF THE INVENTION

The present invention relates generally to data processing, and more particularly to processing digital video recordings. The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

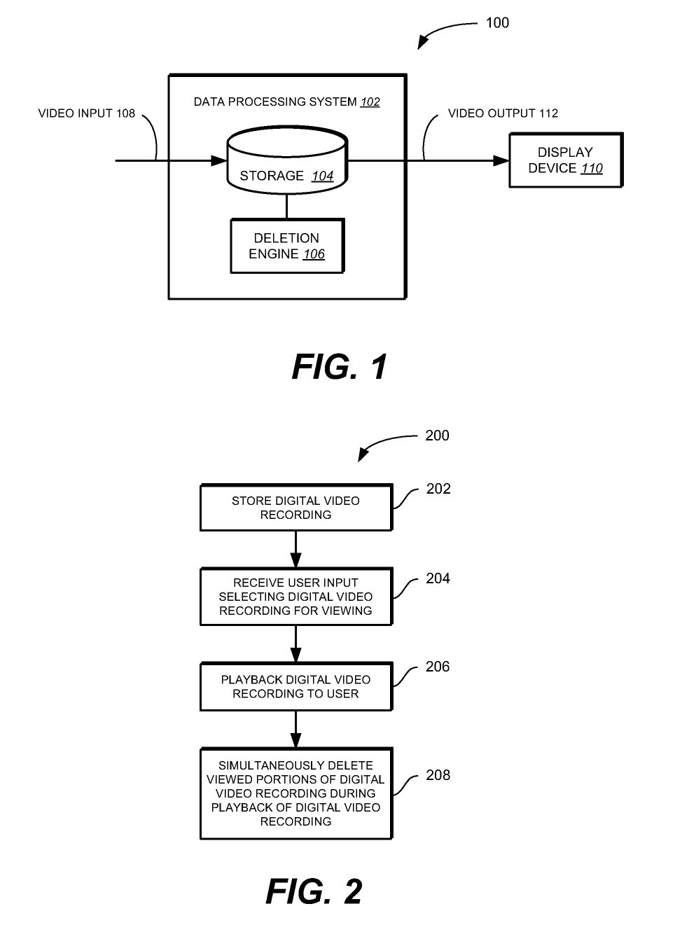

FIG. 1 illustrates one implementation of a data processing system 100 operable to record (or store) a digital video recording. The data processing system 100 can be, for example, a digital video recorder (DVR), a computer system, a set-top box, or other device operable to store a digital video recording onto a disk or other medium. The digital video recording can be a television program, or other type of data. In one implementation, the data processing system includes a storage 104 and a deletion engine 106. In other implementations, the storage 104 and/or the deletion engine 102 can be components associated with hardware separate from the data processing system 100. For example, the storage 104 can be coupled to the data processing system 102 through a wired network or a wireless network (e.g., the Internet). The storage 104 is configured to store a digital video recording (e.g., a television program) received through a video input 108. In one implementation, a digital video recording is a recording of a television program that has previously been broadcast or aired. A user can later view a stored digital video recording through a display device 110 (e.g., a television or computer display monitor) coupled to the data processing system 102 through a video output 112. In one implementation, the deletion engine 106 is configured to delete portions of a digital video recording from the storage 104 as a user is viewing the digital video recording on the display device 112, as discussed in greater detail below.

FIG. 2 illustrates a method 200 for deleting a digital video recording from storage (e.g., storage 104 of FIG. 1) in accordance with one implementation. The method steps of method 200 can be performed by the deletion engine 106 (FIG. 1) as a user is viewing the digital video recording. A digital video recording is stored (e.g., in storage 104) (step 202). The digital video recording can be any type of data. In one implementation, the digital video recording is a television program. In general, the digital video recording can be stored in any type of storage, e.g., a memory, a disk drive, or other medium. User input is received selecting the digital video recording for viewing (step 204). In one implementation, the user input is received through an input device (e.g., a remote or keyboard), and/or a graphical user interface (GUI) that is displayable on a display device (e.g., display device 110 of FIG. 1). The digital video recording is played back to the user (step 206). As discussed above, the digital video recording can be played back (or viewed) on, e.g., a television or a computer display.

As the user views the digital video recording, viewed portions of the digital video recording are simultaneously deleted from storage to free up storage space (step 208). Thus, unlike conventional techniques that require a user to watch an entire recorded television program in one sitting to free up storage space, in one implementation, a user need only watch a portion of a television program in order to free additional storage space. The additional space can be used for the storage of future television programs and/or television programs that are being recorded in the background while the user views a stored recording. In one implementation, a user is provided with the option of setting markers as a digital video recording is being viewed. The marked off sections can then later be subsequently deleted from storage.

### Delete While Viewing

Most users typically record a television program because the users cannot view the television program being aired live. Oftentimes, a user typically only views a recording once and then automatically deletes the recording. In such a case, the techniques disclosed herein permit a user to free up storage space on a recorder immediately after the user has watched a recording. In one implementation, when a user chooses the option to delete a recording as the recording is being played back, the video recorder leaves a buffer (e.g., one minute of playtime) that will allow the user to still view parts of the show that the user may have accidentally skipped over. The buffer also gives a user the option of rewinding a recording to re-view a portion of the recording. In one implementation, a length of the buffer is configurable by a user. For example, such a buffer may be useful in a situation in which a user fast-forwards a recording through a series of commercials (or other boring section of a television program), and the user accidentally fast-forwards too far and misses a small portion of the next scene. In such a case, the recording contained within the buffer would not be deleted and the user can rewind the recording to view a desired portion of the recording.

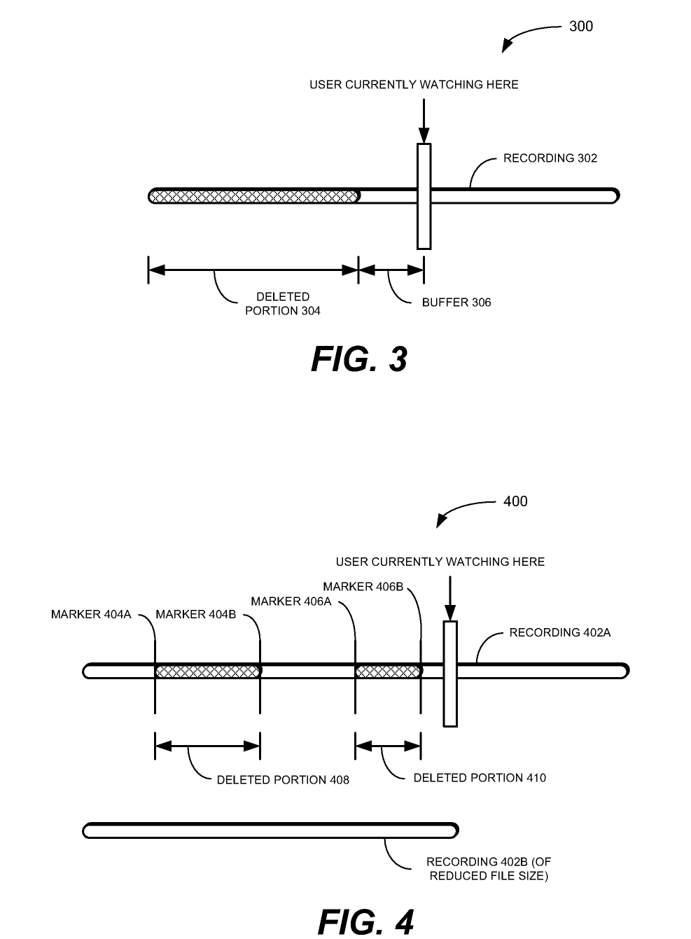

FIG. 3 depicts a graph 300 that illustrates deletion of a portion of a digital video recording 302 in accordance with one implementation. As shown in FIG. 3, a viewed portion of the digital video recording 302 is concurrently deleted as a user views the digital video recording 302. The deleted portion of the digital video recording 302 is indicated by deleted portion 304. In one implementation, a buffer 306 of pre-determined length is maintained such that a portion of the digital video recording 302 contained within the buffer 306 is not deleted. In one implementation, the buffer is one minute in length.

### Deleting Marked Sections

In one implementation, if a user desires to view a recording more than one time, the user can choose to delete only those sections of the recording that the user is not interested in to free up storage space for additional recordings. In one implementation, the deletion engine 106 (FIG. 1) permits a user to set markers throughout a given recording and then provides a set of options as to how portions of the marked recording can be deleted. In one implementation, a user can select to have marked portions of a given recording deleted. Alternatively, the user can select to have unmarked portions of a given recording deleted—i.e., the marked portions of the recording are saved for subsequent viewing. FIG. 4 depicts a graph 400 that illustrates deletion of marked portions of a digital video recording 402A in accordance with one implementation. As shown in FIG. 4, the digital video recording 402A contains two marked sections respectively marked by markers 404A, 404B and markers 406A, 406B. In the example of FIG. 4, marked portions of the digital video recording 402A are deleted as indicated by deleted portion 408 and deleted portion 410. After the marked portions of the digital video recording 402A are deleted, a file size of the digital video recording 402A is reduced as shown by the digital video recording 402B.

### Deletion Prompts

In one implementation, the data processing system 100 provides a functionality that does not automatically delete a recording as the recording is being viewed, but rather allows a user to specify predefined intervals at which the user would be prompted to determine if a particular segment of a recording should be deleted. For example, in a situation in which a user is not sure if sections (or portions) of a given recording are going to be deleted until the user has viewed the recording, the user can set a “prompt” function for a specified time (e.g., every 5 minutes—this would denote a segment). At every 5 minutes, the user will be prompted whether the previously viewed segment should be deleted. The user can respond affirmatively or negatively, in which case the segment will either be respectively deleted from storage or kept in storage.

In one implementation, one or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In one implementation, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

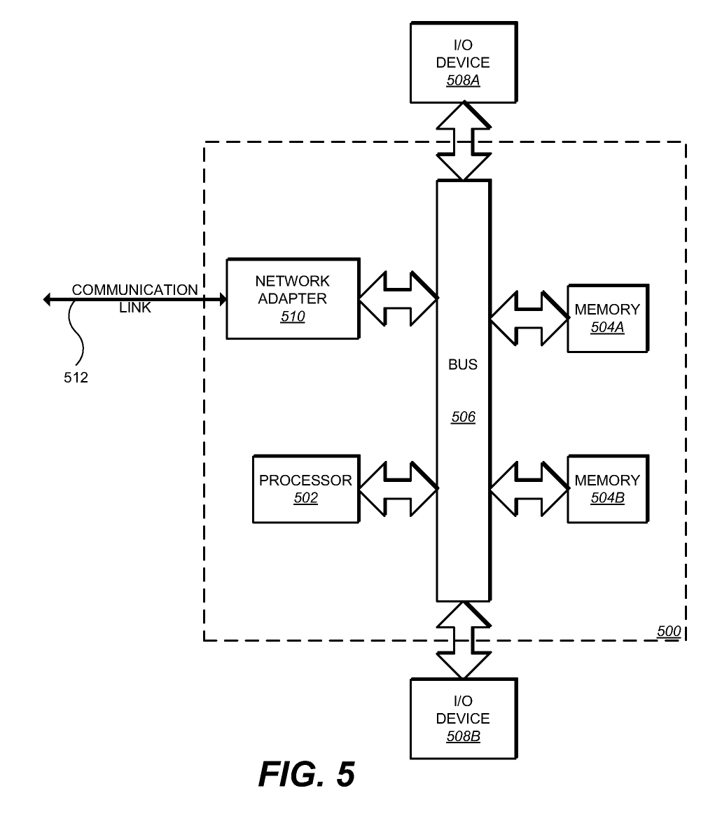

FIG. 5 illustrates a data processing system 500 suitable for storing and/or executing program code. Data processing system 500 includes a processor 502 coupled to memory elements 504A-B through a system bus 506. In other implementations, data processing system 500 may include more than one processor and each processor may be coupled directly or indirectly to one or more memory elements through a system bus. Memory elements 504A-B can include local memory employed during actual execution of the program code, bulk storage, and cache memories that provide temporary storage of at least some program code in order to reduce the number of times the code must be retrieved from bulk storage during execution. As shown, input/output or I/O devices 508A-B (including, but not limited to, keyboards, displays, pointing devices, etc.) are coupled to data processing system 500. I/O devices 508A-B may be coupled to data processing system 500 directly or indirectly through intervening I/O controllers (not shown).

In one implementation, a network adapter 510 is coupled to data processing system 500 to enable data processing system 500 to become coupled to other data processing systems or remote printers or storage devices through communication link 512. Communication link 512 can be a private or public network. Modems, cable modems, and Ethernet cards are just a few of the currently available types of network adapters.

Various implementations for deleting a digital video recording have been described. Nevertheless, various modifications may be made to the implementations. For example, though the techniques described above refer to digital video recordings such as television programs, the techniques are applicable to storage of any type of data. In addition, steps of the methods described above can be performed in a different order and still achieve desirable results. Accordingly, many modifications may be made without departing from the scope of the following claims.

What is claimed is:

1. A method for processing a digital video recording, the method comprising:
storing the digital video recording onto a storage, the digital video recording to be subsequently viewed by a user;
receiving user input selecting the digital video recording for viewing;
responsive to the user input, playing back the digital video recording to the user; and
simultaneously deleting a viewed portion of the digital video recording from the storage as the user views the digital video recording during playback of the digital video recording.

2. The method of claim 1, wherein storing the digital video recording onto a storage includes storing the digital video recording onto a disk drive.

3. The method of claim 1, further comprising:
receiving user input marking one or more sections of the digital video recording with markers during play back of the digital video recording,
wherein simultaneously deleting a viewed portion of the digital video recording from the storage as the user views the digital video recording includes deleting the one or more marked sections of the digital video recording from the storage.

4. The method of claim 1, further comprising:
receiving user input marking one or more sections of the digital video recording with markers during play back of the digital video recording,
wherein simultaneously deleting a viewed portion of the digital video recording from the storage as the user views the digital video recording includes deleting one or more unmarked sections of the digital video recording from the storage.

5. The method of claim 1, further comprising prior to play back of the digital video recording, receiving user input specifying predefined intervals at which the user is to be prompted to determine if a portion of the digital video recording should be deleted,
wherein simultaneously deleting a viewed portion of the digital video recording from the storage as the user views the digital video recording during playback of the digital video recording includes only deleting a viewed portion of the digital video recording responsive to user input affirmatively indicating at a given prompt that the viewed portion of the digital video recording should be deleted.

6. A computer readable medium encoded with a computer program for processing a digital video recording, the computer program comprising computer executable code for:
storing the digital video recording onto a storage, the digital video recording to be subsequently viewed by a user;
receiving user input selecting the digital video recording for viewing;
responsive to the user input, playing back the digital video recording to the user; and
simultaneously deleting a viewed portion of the digital video recording from the storage as the user views the digital video recording during playback of the digital video recording.

7. The computer readable medium of claim 6, wherein the computer executable code for storing the digital video recording onto a storage includes computer executable code for storing the digital video recording onto a disk drive.

8. The computer readable medium of claim 6, further comprising computer executable code for:
receiving user input marking one or more sections of the digital video recording with markers during play back of the digital video recording,
wherein the computer executable code for simultaneously deleting a viewed portion of the digital video recording from the storage as the user views the digital video recording includes computer executable code for deleting the one or more marked sections of the digital video recording from the storage.

9. The computer readable medium of claim 6, further comprising computer executable code for:
receiving user input marking one or more sections of the digital video recording with markers during play back of the digital video recording,
wherein the computer executable code for simultaneously deleting a viewed portion of the digital video recording from the storage as the user views the digital video recording includes computer executable code for deleting one or more unmarked sections of the digital video recording from the storage.

10. The computer readable medium of claim 6, further comprising computer executable code for:
prior to play back of the digital video recording, receiving user input specifying predefined intervals at which the user is to be prompted to determine if a portion of the digital video recording should be deleted,
wherein the computer executable code for simultaneously deleting a viewed portion of the digital video recording from the storage as the user views the digital video recording during playback of the digital video recording includes computer executable code for only deleting a viewed portion of the digital video recording responsive to user input affirmatively indicating at a given prompt that the viewed portion of the digital video recording should be deleted.

11. A data processing system configured to process a digital video recording, the data processing system comprising:
a storage to store the digital video recording for subsequent viewing by a user;
a display device to play back the digital video recording to the user; and
a deletion engine to simultaneously delete a viewed portion of the digital video recording from the storage as the user views the digital video recording during playback of the digital video recording.

12. The data processing system of claim 11, wherein:
the deletion module is configured to receive user input marking one or more sections of the digital video recording with markers during play back of the digital video recording; and
the deletion engine simultaneously deleting a viewed portion of the digital video recording from the storage as the user views the digital video recording includes the deletion engine deleting the one or more marked sections of the digital video recording from the storage.

13. The data processing system of claim 11, wherein:
the deletion module is configured to receive user input marking one or more sections of the digital video recording with markers during play back of the digital video recording; and
the deletion engine simultaneously deleting a viewed portion of the digital video recording from the storage as the user views the digital video recording includes the deletion engine deleting one or more unmarked sections of the digital video recording from the storage.

14. The data processing system of claim 11, wherein the storage is a disk drive.

15. The data processing system of claim 11, wherein the data processing system is one of a digital video recorder (DVR), a personal video recorder (PVR), a computer system, or a set-top box.

16. The data processing system of claim 15, wherein the display device is a computer display or a television.

17. The data processing system of claim 11, wherein the storage is separate from the data processing system.

18. The data processing system of claim 17, wherein the storage is coupled to the data processing system through a wired network or a wireless network.

19. The data processing system of claim 17, wherein the wired network or the wireless network comprises the Internet.
